(19) United States
(12) Patent Application Publication
(10) Pub. No.: US 2021/0084904 A1
(43) Pub. Date: Mar. 25, 2021

(54) SUCCINATE DEHYDROGENASE INHIBITORS AND SULFUR-CONTAINING COMPOUNDS MIXTURES AND METHODS OF USE THEREOF

(71) Applicant: University of Georgia Research Foundation, Inc., Athens, GA (US)

(72) Inventor: Albert K. Culbreath, Tifton, GA (US)

(21) Appl. No.: 17/025,348

(22) Filed: Sep. 18, 2020

Related U.S. Application Data
(60) Provisional application No. 62/903,972, filed on Sep. 23, 2019.

(51) Int. Cl. A01N 59/02; A01N 43/56

(52) U.S. Cl. CPC A01N 59/02; A01N 43/56

(57) ABSTRACT

The present invention is directed to pesticidal mixtures containing one or more succinate dehydrogenase inhibitors (SDHIs) and one or more sulfur-containing compounds. The present invention further relates to methods of controlling a pest by applying one or more succinate dehydrogenase inhibitors (SDHIs) and one or more sulfur-containing compounds to a plant, plant propagation material or an area where a plant will grow.

### FIELD OF THE INVENTION

The present invention is directed to pesticidal mixtures containing one or more succinate dehydrogenase inhibitors (“SDHIs”) and one or more sulfur-containing compounds. The present invention further relates to methods of controlling a pest by applying one or more SDHIs and one or more sulfur-containing compounds to a plant, plant propagation material or an area where a plant will grow.

### BACKGROUND OF THE INVENTION

Peanut leaf spots, including Early leaf spots (Cercospora arachidicola) and Late leaf spots (Phaeoisariopsis personata or Cercosporidium personatum), are the cause of serious disease in many economically important plants including peanut plants. Prevention of peanut leaf spots has been well studied since the discovery of the disease in peanut plants in the late 1990's.

Peanut leaf spot has typically been controlled in peanuts by planting date, seeding rate, the use of resistant cultivars, and the insecticide chlorothalonil. However, peanut leaf spot is not completely controlled by chlorothalonil. Further, chlorothalonil is toxic and may soon be banned in Europe.

Accordingly, there is a need in the art for mixtures that have less toxicity for the prevention of peanut leaf spot.

### SUMMARY OF THE INVENTION

The present invention is directed to a pesticidal mixture of one or more succinate dehydrogenase inhibitors (“SDHIs”) and one or more sulfur-containing compounds.

The present invention is further directed to a method of controlling a pest comprising applying a pesticidal mixture of the present invention to a plant, plant propagation material or an area where a plant will grow.

The present invention is further directed to a method of controlling peanut leaf spot by applying a pesticidal mixture comprising an effective amount of one or more SDHIs and one or more sulfur-containing compounds to a plant, plant propagation material or an area where a plant will grow.

### DETAILED DESCRIPTION OF THE INVENTION

The Applicant has unexpectedly discovered that a mixture of one or more succinate dehydrogenase inhibitors (“SDHIs”) and one or more sulfur-containing compounds is more effective in controlling peanut leaf spot than the commercial standard, chlorothalonil. Further, the Applicant has unexpectedly discovered that a mixture of one or more SDHIs and one or more sulfur-containing compounds is capable of controlling peanut leaf spot.

As used herein, the term “plant propagation material” refers to seeds and seedlings of all kinds (fruit, tubers, and grains), clonal and micro propagated plants, and the like.

As used herein, “improving” means that the plant has more of the specific quality than the plant would have had it if it had not been treated by methods of the present invention.

As used herein, “to control” a pest or “controlling” pest(s) refers to killing, incapacitating, repelling, or otherwise decreasing the negative impact of the pest on plants or animals to a level that is desirable to the grower, applicator or user.

The term “effective amount” means the amount of the formulation that will control the target pest. The “effective amount” will vary depending on the mixture concentration, the type of pest(s) being treated, the severity of the pest infestation, the result desired, and the life stage of the pest during treatment, among other factors. Thus, it is not always possible to specify an exact “effective amount.” However, an appropriate “effective amount” in any individual case may be determined by one of ordinary skill in the art.

The articles “a,” “an” and “the” are intended to include the plural as well as the singular, unless the context clearly indicates otherwise. For example, the methods of the present invention are directed to controlling “pest” but this can include control of a multiple pests (such as a more than one insect or more than one insect species or more than one mite or more than one mite species.

As used herein, all numerical values relating to amounts, ratios, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

In one embodiment, the present invention is directed to a pesticidal mixture comprising an effective amount of one or more succinate dehydrogenase inhibitors (“SDHIs”) and one or more sulfur-containing compounds.

SDHIs suitable for use in the present invention include, but are not limited to, penthiopyrad, flutolanil, pydiflumetofen, benzovindiflupyr, fluxapyroxad, fluopyram and inpyrfluxam. In a preferred embodiment the SDHI is inpyrfluxam.

Sulfur-containing compounds suitable for use in the present invention include, but are not limited to, sulfur and lime-sulfur.

In a preferred embodiment, one or more succinate dehydrogenase inhibitors (“SDHIs”) and one or more sulfur-containing compounds may be present in mixtures of the present invention at a weight ratio of from about 10,000:1 to about 1:10,000, preferably from about 1,000:1 to about 1:1,000, more preferably from about 500:1 to about 1:500 and even more preferably from about 10:1 to about 1:200 and even more preferably from about 1.2:1 to about 1:144.

In another embodiment, mixtures of the present invention further comprise one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and preservatives.

The formulations of the present invention can be applied by any convenient means. Those skilled in the art are familiar with the modes of application that include foliar applications such as spraying and soil applications including spraying, in-furrow treatments, or side-dressing.

Formulations of the present invention may be applied to any plant or plant propagation material thereof that may benefit from improved growth including agricultural crops, annual grasses, trees, shrubs, ornamental flowers and the like. Formulations of the present invention may further be applied to any area where a plant will grow including soil, a plant root zone and a furrow.

In another embodiment the present invention is further directed to a method of improving plant growth comprising applying mixtures of the present invention to a plant, plant propagation material or an area where a plant will grow.

In another embodiment the present invention is further directed to a method of controlling a pest applying mixtures of the present invention to a plant, plant propagation material or an area where a plant will grow.

In a preferred embodiment, the area where a plant will grow includes corn fields, cotton fields, peanut fields and soybean fields. In a more preferred embodiment, the area where a plant will grow includes corn fields, cotton fields and peanut fields.

In a preferred embodiment the area where a plant will grow is soil or a plant root zone.

In a more preferred embodiment, the soil is in the form of a furrow.

In another preferred embodiment, the pest is a fungus, more preferably peanut leaf spot.

In a more preferred embodiment, the present invention is directed to a method of controlling peanut leaf spot applying a pesticidal mixture comprising an effective amount of one or more SDHIs and one or more sulfur-containing compounds to a plant, plant propagation material or an area where a plant will grow.

In another preferred embodiment, the one or more SDHIs may be applied at a rate of from about 0.001 to about 100 pounds per acre (“lb/A”), more preferably from about 0.01 to about 50 lb/A, even more preferably from about 0.02 to about 10 lb/A and most preferably from about 0.04 lb/A to about 0.95 lb/A.

In another preferred embodiment, the one or more sulfur-containing compounds may be applied at a rate of from about 0.01 to about 500 lb/A, more preferably from about 0.1 to about 400 lb/A, even more preferably from about 0.5 to about 100 lb/A and most preferably from about 0.8 g/HA to about 6.4 lb/A.

These representative embodiments are in no way limiting and are described solely to illustrate some aspects of the invention.

Further, the following example is offered by way of illustration only and not by way of limitation.

### EXAMPLES

Excalia™ was used as the source of inpyrfluxam and is available from Sumitomo Chemical Co. Ltd.

Bravo Weather Stik® was used as the source of chlorothalonil and is a registered trademark of and available from Syngenta.

Elatus® was used as the source of azoxystrobin and benzovindiflupyr and is a registered trademark of and available from Syngenta.

Provost® was used as the source of prothioconazole and is a registered trademark of and available from Bayer.

Microthiol® Disperss® was used as the source of sulfur and is a registered trademark of and available from Atofina Chemicals, Inc.

### Example 1—Efficacy of Inpyfluxam and Sulfur Mixture on Peanut Leaf Spot

### Method

The following greenhouse test was conducted Sep. 14, 2019. Peanut plants (Arachis hypogaea) were used in the test as the crop plant. The peanut plants were infected Cercosporidium personatum.

Leaves were sprayed with inpyfluxam, chlorothalonil, benzovindiflupyr, prothioconazole, and/or sulfur at the rates disclosed in Table 1. Results can be found in Table 1, below. All data was analyzed for significance.

### Results

As seen in Table 1, below, a mixture of inpyrfluxam and sulfur provided superior control of late leaf spot compared to inpyfluxam alone.

TABLE 1

| | Application Rate | |
|---|---|---|
| Treatment | Ounces/Acre | % Control |
| Untreated | 0 | 47.5a |
| Chlorothalonil | 24.0 | 27.5c |
| Azoxystrobin | 7.3 | 7.5d |
| Benzovindiflupyr | | |
| Azoxystrobin | 7.3 | 6.3d |
| Benzovindiflupyr | | |
| Prothioconazole | 7.0 | 10.0d |
| Inpyrfluxam | 2.0 | 32.5b |
| Inpyrfluxam | 3.0 | 31.3bc |
| Inpyrfluxam | 4.0 | 30.0bc |
| V-10749 | 11.5 | 31.3bc |
| Inpyrfluxam | 2.0 | 10.0d |
| Sulfur | 80 | |

What is claimed is:

1. A pesticidal mixture comprising an effective amount of one or more succinate dehydrogenase inhibitors (SDHIs) and one or more sulfur-containing compounds.

2. The mixture of claim 1, wherein the ratio of SDHIs to sulfur-containing compounds is from about 1,000:1 to about 1:1,000.

3. The mixture of claim 1, wherein the ratio of SDHIs to sulfur-containing compounds is from about 10:1 to about 1:200.

4. The mixture of claim 1, wherein the ratio of SDHIs to sulfur-containing compounds is from about 1.2:1 to about 1:144.

5. The mixture of claim 1, wherein the ratio of SDHIs to sulfur-containing compounds is about 1:40.

6. The mixture of claim 1, wherein the SDHIs are selected from the group consisting of penthiopyrad, flutolanil, pydiflumetofen, benzovindiflupyr, fluxapyroxad, fluopyram and inpyrfluxam.

7. The mixture of claim 1, wherein the sulfur-containing compound is selected from the group consisting of sulfur and lime-sulfur.

8. The mixture of claim 1, further comprising one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and preservatives.

9. A pesticidal mixture comprising an effective amount of inpyrfluxam and sulfur.

10. A method of controlling a pest comprising applying a pesticidal mixture comprising an effective amount of one or more succinate dehydrogenase inhibitors (SDHIs) and one or more sulfur-containing compounds to a plant, plant propagation material or an area where a plant will grow.

11. The method of claim 10, wherein the SDHI is inpyrfluxam.

12. The method of claim 10, wherein the pest is a fungus.

13. The method of claim 10, wherein the pest is peanut leaf spot.

14. The method of claim 10, wherein the mixture is applied to leaves.

15. The method of claim 10, wherein the plant is a peanut plant.

16. The method of claim 10, wherein the SDHIs are applied at a rate of from about 0.1 to about 100 pounds per acre.

17. The method of claim 10, wherein the SDHIs are applied at a rate of from about 0.04 to about 0.95 pounds per acre.

18. The method of claim 10, wherein the sulfur-containing compounds are applied at a rate of from about 0.01 to about 500 pounds per acre.

19. The method of claim 10, wherein the sulfur-containing compounds are applied at a rate of from about 0.5 to about 100 pounds per acre.

20. The method of claim 10, wherein the sulfur-containing compounds are applied at a rate from about 0.8 to about 6.4 pounds per acre.
